(19) United States
(12) Patent Application Publication
(10) Pub. No.: US 2016/0250566 A1
(43) Pub. Date: Sep. 1, 2016

(54) Chromatography Column

(71) Applicant: Daniel Michael BAILEY, Hampton, NH (US)

(72) Inventor: Daniel Michael Bailey, Hampton, NH (US)

(21) Appl. No.: 14/347,194

(22) PCT Filed: Sep. 25, 2012
(86) PCT No.: PCT/IB12/03142

§ 371 Date: Mar. 25, 2014

Related U.S. Application Data
(60) Provisional application No. 61/539,667, filed on Sep. 27, 2011.

(51) Int. Cl. B01D 15/20; B01D 15/22; G01N 30/60

(52) U.S. Cl. CPC B01D 15/206; G01N 30/60; B01D 15/22; G01N 2030/027

(57) ABSTRACT

A chromatography column and method of packing and maintaining a stable chromatography bed has been set forth where chromatography column is made from a cylindrical tube and an axially inserted plunger. The chromatography bed has a fixed column height. Opposing media screens may be used to contain the media solid components. A flange may be placed on the cylindrical tube to restrict any outward movement of the tube when the chromatography column is actively being packed and used. This flange is often located on the cylindrical tube periphery opposite the position of the plunger face when the plunger has been properly inserted into the cylindrical tube.

### FIELD OF THE INVENTION

This invention relates to liquid chromatographic column equipment and methods, used to prepare and maintain packed beds of chromatographic media.

### DESCRIPTION OF THE PRIOR ART

Liquid chromatography is a term that refers to the separation of compounds carried in a liquid mobile phase, as the mobile phase passes over or through a stationary phase. The stationary phase or ‘packed bed,’ is commonly formed by consolidating a slurry consisting of chromatographic beads or ‘media’ in a liquid into a packed bed. The packed chromatography bed then is used to selectively purify a wide variety of compounds, notably expressed recombinant proteins and other biologically active substances. This process has become widely practiced as a purification operation in many industries.

There are two distinct stages associated with liquid chromatographic operations. First, a loose mixture of resin or media must be packed into an empty column to form a stable chromatographic bed. Once packed, a specific column is then operated once, or several times, in accordance with a desired sequence of steps where liquid mobile phases are passed over the chromatographic bed to selectively purify compound(s) of interest.

Liquid chromatography is used from small scale for analytic purposes to large scale for material preparation. A preparative liquid chromatography column having a packed bed diameter generally greater than 10 cm is commonly referred to as a process chromatography column, and is used to purify large quantities of crude substance into a progressively refined substance. The transition in the field of chromatography from the small-scale (analytical) to the large-scale (process) chromatography column has resulted in the development of columns with increasing diameters to maximize bed volumes and related production capacity.

Large diameter beds are a technical challenge for chromatography columns for several reasons. Production operations commonly include the pressurization of liquid lines and columns and a forced convective flow through the packed bed. The columns or cylinders are under internal pressures that can cause radial and axial expansion and/or to a resulting bed deformation, along with a possible loss of stationary phase sealing. It is desired that uniform liquid flow be distributed to the packed bed, pass through the packed bed cross-section must be distributed to the packed bed, and then be collected at the opposing outlet.

A stable, non-deteriorating packed bed is desired for acceptable chromatographic purification activities. U.S. Pat. No. 5,021,162 by Sakimoto et al. discloses equipment and methods for such bed packing.

Rigid, relatively non-expanding cylinders are an ideal and commonly chosen material for chromatography column cylinder or tube construction. Packed bed stability as well as liquid seal maintenance generally cannot tolerate any significant expansion of a cylinder wall. For these reasons, materials such as steels, (stainless steel and hastelloy), borosilicate glass, acrylic, and polycarbonate have been used in the past, notably for process scale chromatography columns.

Functional chromatography columns require process fittings and flow distributors, which connect to a process line of relatively small diameter and large flow velocity, which then expand to the relatively large diameter of the column and low flow velocity. These distributors may be either above or below the chromatography column. The flow distributors usually include a screen to maintain the chromatographic media within the tube cavity, while allowing the mobile phase to pass through in a uniform manner. Flow distributors can also act as flow collectors when they act to collect the fluid after it has traversed the chromatography column, but for simplicity either configuration will be referred to as a flow distributor. Examples of such flow distributors are described in U.S. Pat. No. 6,736,974, the teachings of which are incorporated herein by reference in their entirety.

COLUMN PACKING: To prepare a chromatography column for use, a media slurry or gel is placed in a vertically disposed column cavity. The media slurry is then compressed into a packed and stable bed within the column cavity and sandwiched between the opposing flow-cells by a variety of methods. Several methods and devices have been proposed to accomplish this preparation activity.

COLUMN OPERATION: To operate a chromatography column comprised of a packed media bed, the mobile phase is pumped or forced through the porous packed bed. The ideal flow through the bed has a uniform profile across the cylindrical cross section, allowing for even exposure of the stationary phase to the mobile phase. Flow-cells included in the desired column design provide even distribution of flow from the process connection, having a smaller internal diameter (ID) to the larger column ID, and for even collection of flow at the opposite end of the column.

Since packing a stable chromatography bed in preparation for use as a purification unit operation can be a complex task, depending on the bed geometry, chromatography column device and method of use, and chromatographic bead physical properties, among other considerations, it has become prevalent to supply pre-packed chromatography columns to end-users interested solely in the use of chromatography columns for separations. Small scale pre-packed analytical columns have been commercially available in many formats for quite some time. Now, with the advent of large scale therapeutic protein production, the need for pre-packed columns of process scale sizes has arisen. Special considerations apply for such a pre-packed column, since traditional steel or glass columns are too cumbersome and costly to effective transport and supply.

WHAT IS CURRENTLY MISSING: An industry-wide need exists for large scale, greater than 10 cm ID, chromatography columns of primarily plastic design, to minimize weight and cost, operable at hydraulic pressures while supporting and maintaining a stable packed bed. Also, devices optionally supplied pre-packed or in a ready to operate configuration for purification operations are of demand by the purification industry.

Also missing in the industry is a low cost column design capable of being packed with resin with a simple drive system, either as a pre-packed column or packed by an end-user.

Disclosed herein is a column and method that addresses these and other unsolved problems characteristic of packing and operating chromatographic beds.

### SUMMARY OF THE INVENTION

Disclosed herein are new devices and methods of their preparation that provide process, at least, chromatographic beds. The devices comprise chromatography columns of primarily thermoplastic construction, each device comprising a cylinder (tube) and at least one piston like plunger, and, in some embodiments, a backing ring used to facilitate the column assembly, which may also restrict radial expansion of the column body. Preferred embodiments of the invention may employ new attachments and extra systems that control plunger movement. The invention includes the following, alone or in combination.

A thermoplastic chromatography column, comprised of a plunger and cylinder (tube) constructed from thermoplastic material.

A chromatography cylinder (tube) with an integrated flange used as an assembly aid and also as radial reinforcement of the cylinder wall.

A slip-on backing ring, abutting an integrated cylinder flange and impinging a cylinder exterior, which can limit radial cylinder expansion. This backing ring may have an inner diameter or inner profile to match the cylinder or cylinder hub outside diameter.

A tube with an integrated flange and restrictor hub.

A tube and plunger with recessed process fittings comprising a chromatography column.

At the outset, the invention is described in its broadest overall aspects, with a more detailed description following. It will be understood that the particular embodiments of the invention are shown by way of illustration and not as limitations of the invention. Features of one embodiment may be omitted and/or combined with features from another embodiment. The features of the compositions and methods of the invention will be set forth in the claims.

ADVANTAGES SUMMARY: The present invention has many advantages. A few are described below. The devices and methods according to various embodiments of the invention enable the assembly of a chromatography column consisting of a cylinder (tube), and a plunger, and the fastening of opposing flow-cells to form and contain a packed chromatography bed. The invention also enables the use of flexible cylinder materials, such as polypropylene and polyethylene, at diameters normally not permissive due to radial expansion, by innovations to restrict radial cylinder expansion. In addition, a disclosed restrictor ring may be used to reduce the cylinder (tube) inner diameter at a given location to allow the application of a stabilizing compression to the packed chromatography bed. Also, disclosed recessed process connections enable the formation of a robust column well suited for transportation and operation with limited potential for critical damage to the process connections.

### BRIEF DESCRIPTION OF THE DRAWINGS

The foregoing and other objects, features and advantages of the invention will be apparent from the following description of illustrative embodiments of the invention, as illustrated in the accompanying drawings. In these drawings, like reference characters refer to the same parts throughout the different views. The drawings are not necessarily to scale, emphasis instead being placed upon illustrating the principles of the invention.

The particular features and advantages of the invention as well as other objects will become apparent from the following description taken in connection with the accompanying drawings:

FIG. 1 depicts a cut-away elevation view of a column assembly in a packed state.

FIG. 2 depicts a cut-away elevation view of a column cartridge and frame in a packed state.

FIG. 3 is a cut-away elevation view of a chromatography tube.

FIG. 4 is a cut-away elevation view of the chromatography plunger.

FIG. 5A is cut-away elevation view of a restrictor hub with a restrictor flange in an approaching position.

FIG. 5B is a cut away elevation view of a fully engaged restrictor flange and hub.

FIG. 6 is an alternate embodiment comprised of a tube with two plungers

### DETAILED DESCRIPTION OF THE INVENTION

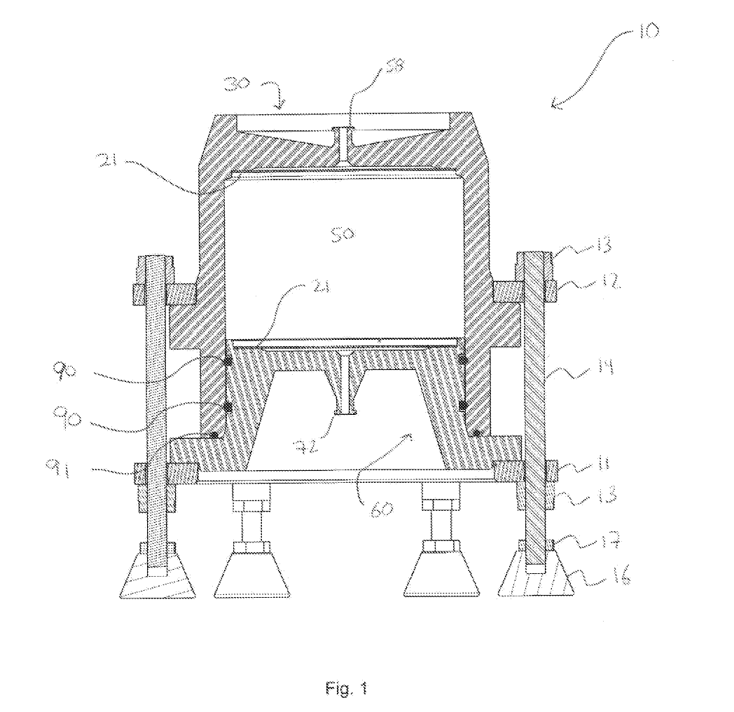

CHROMATOGRAPHY COLUMN: FIG. 1 shows a cut-away elevation view of a first embodiment of the present invention, an axially fixed height plunger packed chromatography column with seals 90 between the plunger and the enveloping cylindrical tube. The chromatography column 10 consists of a tube 30 and a plunger 60 which when inserted into the tube cavity 50 forms a pressure vessel of cylindrical form where a packed chromatography bed may be formed. As the plunger 60 travel through the inner cavity 50 a seal is formed by the compression of a piston seal 90 within a gland 62 of the plunger and the tube cavity wall 59. The plunger when inserted to a desired depth within the tube forms a pressure resistance liquid cylindrical chamber or vessel with a specific axial height, or bed height.

The plunger 60 is secured in position by a plunger backing ring 11 abutting an integrated plunger flange 63 fastened to a cylinder backing ring 12 via retaining rods 14 and nuts 15 shown here with threaded fastenings, although other mechanical fastening such as clevis pins, cotter pins, or clamps may be used. Optional footings 16 with an internal threaded diameter fixed to a threaded end of retaining rods 14 can be secured with jam nuts 17 to level the column 10 and provide a secure and stable support. Manual manipulation, such as lifting and inversion of the chromatography column can be accomplished by a lift or hoist and rigging. The retaining rods 14 and nuts 13 are constructed of rigid material such as metals or reinforced plastics such as glass filled thermoplastics. The backing rings are constructed from structurally strong materials, such as metals, fiber filled plastics, or composites.

FLOW DISTRIBUTORS AND COLLECTORS: Flow distribution is critical to column performance and requires uniform liquid flow over a circular face. A flow distributor must retain the beads or media, uniformly distribute axial liquid flow, effectively deflect liquid flow direction from axial to radial, maintain radial dispersion channels, and avoid column ‘blinding’, i.e., a blockage of fluid flow and/or non-uniform distribution of the liquid. Connections to process lines must be robust, and for that reason hygienic clamps as defined in the ASME BPE 2009 specification are often used. During operation of the column cartridge 10, either process fitting 72 or 58 can act as an inlet or outlet depending on flow direction. The flow distributors of this invention usually also maintain the even radial flow dispersion while under mechanical pressure applied by the ‘packed’ media bed. This is often accomplished with a radial rib or channel pattern machined into the media oriented face of either the distributor or the collector, whose rolls may be reversed in given chromatography column functioning. Sanitary design of the distributor is often a third requirement or distributor design, along with efficient flow distribution and effective vessel sealing. Various designs of flow distributors are suitable for use in embodiments of the invention provided they achieve the above criteria.

Prior to packing, functional flow distributors and collectors are usually fabricated by securing media screens 21 in media screen cavities. The media screens can be fused or sealed at the perimeter of the media screen cavities to form media retaining seals, such as by heat contact bonding or rod welding. The media screens 21 are generally constructed of a porous material such as a filter cloth or a screen with openings of a size and uniformity that is sufficient to retain the chromatographic material to be packed. Additionally, an irrigation layer (not shown) may be added between the media screen and the supporting distributor and/or collector face. This irrigation layer may be a simple layer such as a disk of coarse mesh or a more complicated design, including flow channels and ribs either machined directly into the supporting distributor face or placed as a layer between the media screen and the supporting distributor face.

It should be noted, that although no graphical representation of a packed bed has been made in the associated figures, a packed chromatography bed would be located in the cavity 50.

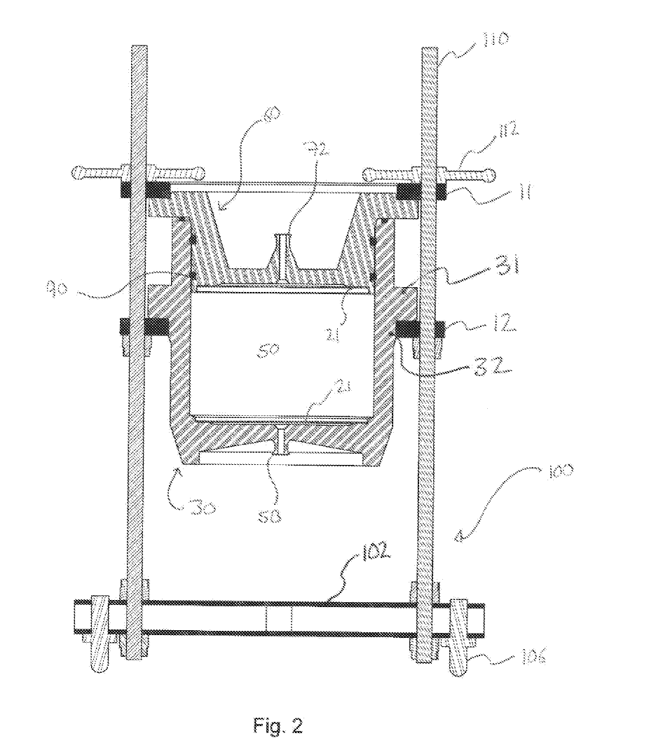

PACKING: Packing is accomplished by forcibly inserting the plunger into the tube cavity. This insertion can be accomplished by a variety of linear motion drives. FIG. 2 shows a simple, yet functional, drive system which has at least two drive screws 110 with threaded sections, longitudinally aligned within the backing ring bolt holes of plunger backing ring 11 and cylinder backing ring 12, and fixed to a frame base 102 support to maintain the drive screw configuration until the column 10 is removed for transport or other purpose. Additional items may be added to the frame to support the drive screws. The frame of FIG. 2 can be used repeatedly to orient a chromatography column 10 and thereby allow the operation of moving plunger 60 through tube 30. This movement achieves and secures a desired column height of the media screens 21.

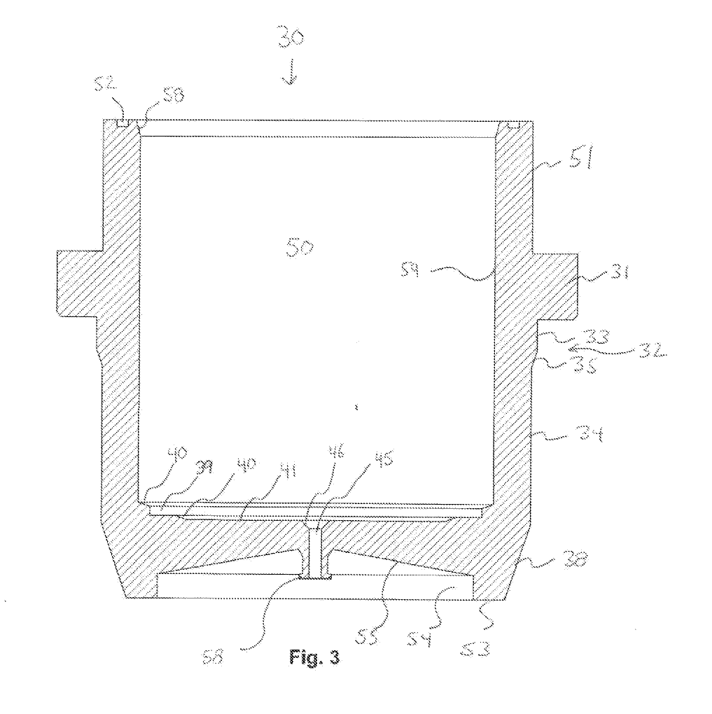

The method of forming a packed chromatography column is initiated by threading at least two nuts 13, to two drive screws 110 until the at least two nuts form a level plane between themselves. A backing ring 12, which may also act as a restrictor ring is then added to the top of the aligned at least two nuts 13. Next, a cylindrical tube 30 as shown in FIG. 3 is inserted into the backing ring 12 to be supported by the integrated flange 31 or possibly the hub 32 on tube 30. An initial slurry or consolidation of chromatography media is added to tube 30. A plunger 60 is then aligned at the tube 30 inlet and plunger ring 11 is used to drive the plunger into tube 30 via the thrust caused by drive nuts 112 rotating on the drive screws 110 to axially compress bed cavity 50 and any contents within. With the packing stroke completed, the chromatography column is removable from the frame 100 by fixing the plunger in position, as shown in this embodiment by the addition of at least two retaining rods 14 and at least four nuts 13 appropriately placed within unoccupied backing ring and plunger ring bolt holes (not shown in FIG. 2 but shown in FIG. 1) to retain the plunger and tube. With the retaining rods 14 installed and fixing the column 10 in a sealed and static position, drive nut 112 can be released to allow for the longitudinal extraction of the packed column from the frame [100]. Additionally, a set of footings 16 can be secured to the portion of retaining rods 14 extending past the plunger backing ring 11 to achieve a readily installed and leveled stand after the inversion of the column to match the longitudinal orientation of FIG. 1.

In this depicted embodiment, a packed bed of chromatographic material can be formed, with a final piston like compression of the chromatography media bed induced by introduction of a plunger into the cylindrical tube cavity.

RESTRICTOR RING AND HUB: The plunger 60 must form a watertight, pressure resistant piston seal to tube cavity wall 59. The compression of gaskets 90 within glands 61 and 62 forms this seal that is critical for column operation. A lack of compression of this seal may allow liquid to leak, or more disastrously, chromatography media to penetrate the seal, escape the tube, and cause a disruption of the packed bed. The degree of compression or pressure resistance of this piston seal is a controlling factor for performance of the chromatography column. If the tube should swell or expand at the piston seal position and cause an increased in tube cavity diameter, the percent compression of the piston seal, before seal leakage, is reduced. Typical compression of seals can range from 0.01″ to 0.10″. Expansion of cylinders in excess of 0.01″ can result in significant seal decompression; therefore, only a small tube expansion can jeopardize the piston seal and associated chromatography column functionality.

A tube backing ring 12 with a restricting inner diameter can be used to limit tube expansion at a selected tube height location, and/or possibly constrict a tube to a diameter less than its native dimension. FIG. 1 shows an embodiment of the restrictor ring and hub 32 identified by the tube backing ring 12 which when fabricated with a precision inner profile 18 can also function as a restrictor ring with respect to the tube diameter. The restrictor assembly embodiment of FIG. 1 is a relatively simple design, consisting of the restrictor (tube backing) ring 12 with an inner profile which has a taper region 25 and a vertical region 24. Taper region 25 allows for the gradual transition or reduction of the tube 30 diameter. The chamfer 35 of the restrictor ring self aligns with the tube taper 25. When fully engaged the vertical face 24 of the restrictor ring and outer vertical face of the tube 30 engage.

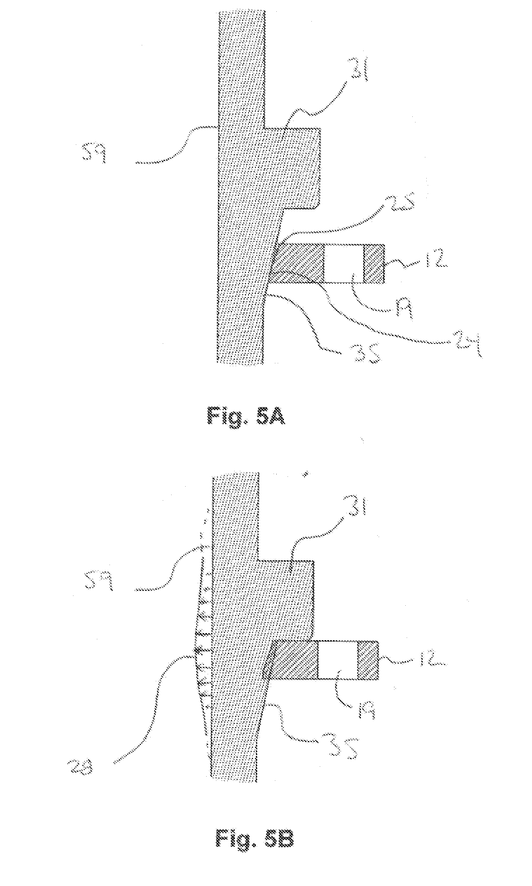

FIGS. 5A & 5B show an alternative form of the restrictor (tube backing) ring 12. In this embodiment the restrictor hub 32 of the tube 30 has a reducing taper 35 section. The matching restrictor ring 12 is shown with a conical taper 25 as well and a relatively small vertical section 24. FIG. 5A shows a first position, where the restrictor ring 12 has not been forcibly driven into position flush with the tube flange 31 horizontal mating wall. FIG. 5B shows the arrangement after the restrictor ring has been positioned by use of a drive system, such as the frame 100, after which the chromatography apparatus of FIG. 2 can function. The restrictor ring is forced to a flush position against the horizontal mating wall of the integrated tube flange 31, and during this operation the tube wall 59, being made of a more flexible material than the restrictor ring, yields to some degree. As shown in FIG. 5B, the restrictor ring, with its relatively strong material will compress the tube wall on its exterior surface, and to some degree reduce the inner diameter of the tube. The restrictor ring therefore acts with a dual function: 1) to help maintain the plunger in position against internal pressure, and 2) to reduce the tube diameter or restrict the tube diameter from expansion. The reduced column diameter at the tube wall 59 is shown as a constriction 28 of the tube inner diameter formed by the engagement of the restrictor ring.

The conical taper 25 of both the restrictor (tube backing) ring 12 and the restrictor hub 32 are critical components of this element of the invention. The sloping surfaces of reducing taper 35 and conical taper 25 are needed to allow the gradual engagement of the restrictor ring 12 with the tube flange 31.

The ideal location of the restrictor hub 32 is at a location between the planes of the media screens when the chromatographic media bed is packed, so that restrictor (tube backing) ring 12 is at some position adjacent to the packed bed is formed. This is the region most likely to experience an internal pressure and possible radial expansion of the tube. Placement of the restrictor (tube backing) ring 12 with a location bias in alignment with the plunger face is also preferable, since limiting the inner diameter surface of tube 30 forming the piston seal is a major objective in order to maintain said piston seal, and as such the tube diameter restriction is at its greatest at an alignment location equal to the restrictor ring engagement position.

Compression of the chromatography media bed is acceptable and often desired. An inward radial and axial force applied to the wall and ends of a packed chromatography bed can help maintain bed stability. This is applicable to rigid material or beads with limited compressibility. There usually is an allowance for some flexibility of the column chromatography media material. There should be an accommodation for limited compressibility of the chromatographic media and for the maintenance of an active squeeze on the packed bed. The restrictor ring and restrictor hub 32 when fully engaged as shown in FIG. 5B, acts to reduce the tube column diameter and available volume for the packed bed, thereby compressing any contained chromatography material. This compression yields a consistent compressive and stabilizing force on the packed bed.

Many possibilities for restrictor hub 32 and restrictor (tube backing) ring contacting faces and profiles will present themselves to the skilled artisan depending on the degree of restriction and magnitude of force required for the installation of the ring. Several of these profiles have been shown, but any complying system is envisioned as being embodiments of this invention.

CYLINDER (TUBE): An embodiment of tube 30 is also shown in FIG. 3. The tube interior has a cylindrical cavity 50 with an inner cylindrical wall 59. The tube exterior is also cylindrical possibly transitioning to a chamfered section 38 surrounding process fitting 58. At the bottom of the interior cylindrical space near process fitting 58, a second cylindrical media screen cavity 39 is located having a minimal depth, with possibly a second chamfered or perpendicular section 40 and an interior tube face 41, further transitioning to an inner diameter 45, concentric with the axis of cylindrical surface 59. The inner diameter 45 is perpendicular to the tube face 41, possibly with a chamfer transition 46.

The exterior of tube 30 may have a face gland 52 cut into the axial face of the tube top edge. The tube 30 has an outer cylindrical wall 51 concentric to the tube cavity, an integrated flange 31 consisting of an outmost diameter with a thickness and horizontal reductions in diameter to form opposing flange faces, and an adjacent restrictor hub 32, which has a conical or tapered section 35 and possibly, as shown in this embodiment, a horizontal section with a thickness and constant diameter 33. Additionally, tube 30 can have possibly a third or additional concentric exterior diameter 34 leading to the concentric chamfered section 38.

The exterior bottom of the tube has a bottom edge 53 of a thickness transitioning to a bottom cylindrical cavity 54 which further transitions to a reducing taper 55. Reducing taper 55 forms a reduction in base thickness of the tube and then to the process fitting 58. Process fitting 58 is in communication with the inner tube cavity via inner diameter 45. These features of the bottom tube region yield a recessed process fitting 58, that while accessible for process connection hook-up is also protected from damage or impact by its location within the closed tube end.

The cylindrical part of tube 30 lends itself to a fabrication from a single form of base material with the starting form of the tube a length of rod-stock or molded near-shape. Although any material could possibly be used, ideal materials are lightweight, easily machined, pressure resistant, and chemically inert. Therefore polypropylene (PP), polyethylene (PE), acetyl, and other thermoplastics are highly suitable choices. Also of note for this invention is that flexible cylindrical tube materials, such as the aforementioned PP, PE, and Acetyl may be selected due to their compatibility with a radial restriction or tubular diameter reduction imposed by a restricting ring.

For preparative column chromatography purposes, the tube may range in inner diameter from 7 cm to 45 cm or larger. Its height may also vary from 20 cm to 50 cm or larger.

As previously described, a media screen, such as a cloth woven from plastic or metallic monofilaments, may be fused into the screen cavity 39 at the perimeter, such as with thermal fusing, to form a functional flow collector/distributor. The shown tube also has a gap formed by chamfered or perpendicular section 40 for the placement of an irrigation layer to allow for radial flow of a liquid stream either to or from the packed chromatography bed.

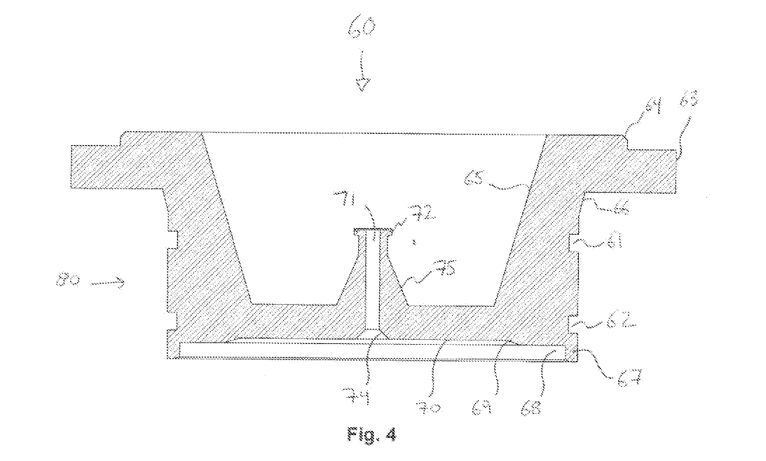

PLUNGER: An embodiment of plunger 60 is shown in FIG. 4. The plunger has a rod or barrel section 80 with a precision diameter and length, a plunger flange 63, a process connection 72 in communication with plunger face 70 via an inner diameter 71. A possible chamfer 66 may by incorporated at the transition from the plunger flange to the outer portion of barrel section 80. Plunger 60 has an excavated top section, forming an interior conical wall 65. In other embodiments the interior wall can be vertical, thereby forming a cylindrical cavity. At the base of this cavity is located process fitting 72, shown in this embodiment with a conical base 75 for robustness. Such a conical base is not required; any functional shape is suitable. The recessed process fitting 72, while capable of being accessed for connection hook-up offers a protected fitting with the same benefits as described for the process fitting 58 of tube 30.

The plunger exterior consists of plunger flange 63 concentric to the outer portion of barrel section 80, and a hub 64 positioned adjacent and concentric to plunger flange 63. The outer portion of barrel section 80 has one or more glands 61 & 62, generally of rectangular shape machined into the outer barrel section wall. A first gland 62 or primary gland is positioned near the piston face 70 and media screen cavity 68. This media screen cavity 68 is fabricated at a depth to minimize the area of stagnant volume within the packed chromatography bed. Additional glands 61 may be added for additional liquid sealing and for plunger alignment during longitudinal actuation of plunger 60.

The plunger face of plunger 60 has a distinct piston lobe 67 transitioning to an interior cylindrical wall to form media screen cavity 68. Within media screen cavity 68, a media screen (not shown in FIG. 4) is placed and sealed at its perimeter to form a seal, such as with thermal sealing, so that media particles are not allowed to escape tube cavity 50. The plunger may have additional cavities or feature on the plunger face to accommodate an irrigation layer for adequate flow expansion/collection. This is shown in this embodiment as the layer formed by the chamfer 69 section as it transitions to plunger face 70.

Plunger 60 lends itself to a fabrication from a single form of base material with the starting form of the plunger a length of rod-stock or molded near-shape. Although any material could possibly be used, ideal materials are lightweight, easily machined, pressure resistant, and chemically inert. Therefore polypropylene (PP), polyethylene (PE), acetyl, and other thermoplastics are highly suitable choices.

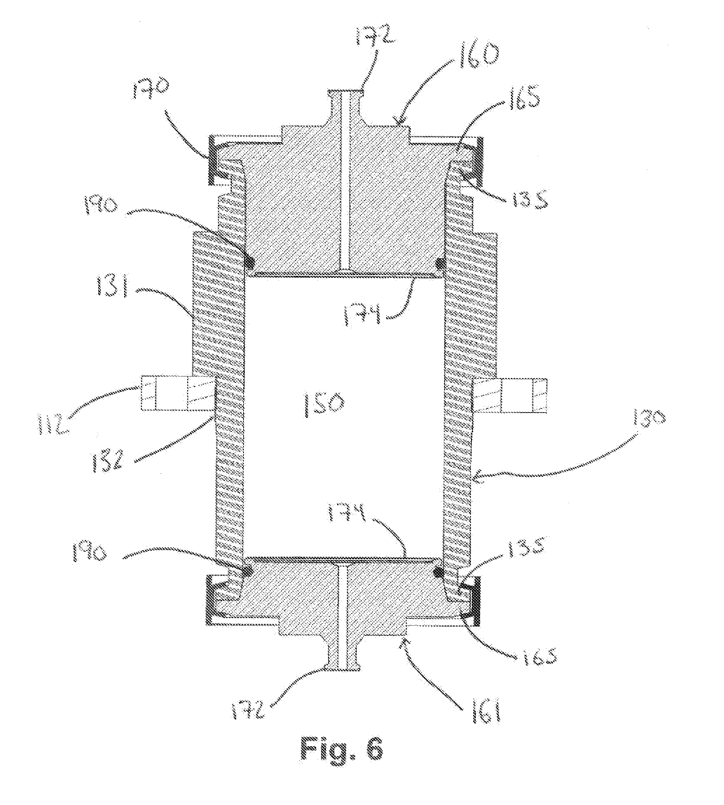

ALTERNATIVE COLUMN EMBODIMENT: FIG. 6 shows an alternative for the column 110. In this embodiment the tube 130 has two open ends, as opposed to a single opening. Two plungers, a top plunger 160 and a bottom plunger 161 are used to form a cylindrical cavity 150 for the containment of a packed chromatography bed within tube 130.

The function of the column, with regards to packing technique and materials of construction, is described by the previous embodiments of FIGS. 1, 2, 3 and 4. In both plungers, top and bottom, 160 and 161, there is a process fitting 172 and media screen 174. The top piston, which will be used for the final axial packing of the column, is driven into the cylinder via linear force and uses o-rings for piston seals 190. The integrated flange 131 will be instrumental to forcibly insert either plunger into the tube, notably during a packing operation, using a drive system or frame 110 as shown in FIG. 2

A notable difference is tube 130 with two open ends. This design requires two tube flanges 135 located at both ends of the tube, shown as ferrule type flanges. These flanges will mate with the matching plunger flanges 165 and be secured with a V-band clamp 170. By means of this clamped mechanical fastening, the backing ring 112 is not required for plunger fastening or column assembly, and may therefore be removed after the both clamps 170 are secured. The use of a two-piece backing ring, such as from Marzolf Company, is useful to successful remove the backing, which if not separable would not clear the newly installed V-clamp.

Additionally, the restrictor hub as previously described can be used to restrain axial expansion of the column wall supporting the packed bed. Alternatively, the radial strengthening may be accomplished by add one or more band clamps, around the diameter of the cylinder.

PROCESSING THE CHROMATOGRAPHY MEDIA SOLUTION: The operational state of column 10 is as a shown in FIG. 1 when a packed chromatography bed has been formed in cavity 50. A process line capable of supplying liquid buffers and feedstock is connected to either process fitting 58 or fitting 72. Liquid is forced or otherwise directed into one end of the column through one of the inner most diameters 45 or 71 as a fluid inlet, normally by gravity and/or by an external pump and control system. The fluid exits the column at the opposed process fitting at a fluid outlet. The liquid is formulated as controlled volumes and compositions. Care is normally taken to avoid air entrainment within the column cartridge, since this can cause blinding of the distribution system. Generally, a volume of purified, and possibly concentrated material of interest is eluted from the chromatography column. The column then may be cycled and used again to purify additional amounts of material.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed herein is:

1. A chromatography column comprising:
(a) a cylindrical tube having at least one open end with an inner diameter about a central axis forming a cavity, an integral exterior flange about a central axis of a diameter greater than said cylindrical tube outer diameter with a location distinct from either end, and a first hub on said cylindrical tube exterior wall adjacent to said integral exterior flange of a constant diameter between that of said outer diameter of said cylindrical tube and that of said integral exterior flange outer diameter, and a second hub whose thickness profile has a reducing taper section with a reducing taper diameter less than that of said first hub;
(b) a backing ring having an inside diameter in close tolerance to or less than the cylindrical tube hub outer diameter, limiting or restricting cylindrical tube expansion along the hub perimeter and positioned, at least partially, within the vertical elevation of said first hub or said second hub; and
(c) a plunger which may be inserted into the open end of said cylindrical tube, having a cylindrical portion with an outer diameter about a central axis, one or more glands for containing circular seals, an integral flange with an outer diameter greater than said cylindrical tube outer diameter, a hub atop said integral flange with an outer diameter less than that of said plunger integral flange, a fluid inlet in communication with the plunger face via an inner diameter vertical hole, a media screen secured to the perimeter of a shallow cylindrical region whose diameter is less than that of said plunger outer diameter and which is located at the plunger face, with the final plunger face vertical position, when said chromatography column is assembled, in proximity to vertical position of said cylindrical tube flange and hub.

2. The chromatography column of claim 1 with a packed bed of media secured between opposing media screens, wherein the second media screen is secured to the perimeter of a shallow cylindrical region at the inner face of said cylindrical tube cavity and whose diameter is less than that of said cylindrical tube outer diameter.

3. A chromatography cylinder constructed from a single piece of thermoplastic comprising:
(a) a first inner diameter about a central axis along the majority of its longitudinal length forming a first cavity;
(b) the first inner diameter reducing to a second inner diameter;
(c) the second inner diameter reducing to a third inner diameter;
(d) at least one interior step with a distinct perimeter vertical thickness formed at the second or third diameter;
(e) a second cavity with a first inner diameter about said central axis that is vertical, optionally with a vertically tapered cylindrical face formed by a large reduction from said second cavity first inner diameter to a second, reduced inner diameter;
(f) a process connection in communication with said chromatography cylinder face via an inner diameter hole to said first cavity; and
(g) an exterior flange about a central axis with a vertical thickness whose vertical location is distinct from either end of said chromatography cylinder.

4. The chromatography cylinder of claim 3 with an outer hub perpendicularly intersecting one of said exterior flange sides with a first profile of a constant diameter with a distinct vertical thickness and a second profile of a reducing taper from the outer diameter of said first profile and with a distinct vertical thickness.

5. The chromatography cylinder of claim 3 with a recessed bottom inlet contained within said second cavity.

6. The chromatography cylinder of claim 3 with a disk like media screen fused or welded into said at least one interior step with a distinct perimeter vertical thickness.

7. The chromatography cylinder of claim 6 with a disk of coarse mesh layered between the bottom of said first cavity and said media screen.

8. A chromatography column plunger derived from a single piece of thermoplastic material comprising:
(a) a rod with an outer diameter along a central axis with one or more glands;
(b) a fluid inlet in communication with the plunger face via an inner diameter hole;
(c) a plunder perimeter of a vertical thickness;
(d) a thin first cylindrical cavity, at the plunger face opposite to that with said fluid inlet, whose diameter is less than that of said rod outer diameter;
(e) a flange with a outer diameter and vertical thickness; and
(f) a hub of a diameter and thickness atop said flange with an outer diameter less than that of said flange.

9. The chromatography column plunger of claim 8 with a second cavity, opposite said first cavity with an inlet hole to said first cavity, forming an open vessel contained within the plunger exterior walls.

10. The chromatography column plunger of claim 8 with a media screen welded into said thin first cylindrical cavity.

11. The chromatography column plunger of claim 10 with a disk of coarse mesh layered between said media screen and the innermost region of said thin first cylindrical cavity.
